(19) United States
(12) Patent Application Publication
(10) Pub. No.: US 2015/0262217 A1
(43) Pub. Date: Sep. 17, 2015

(54) USER PATH ABANDONMENT ANALYSIS

(71) Applicant: Google Inc., Mountain View, CA (US)

(72) Inventor: Neil Hoyne, Santa Clara, CA (US)

(73) Assignee: Google Inc., Mountain View, CA (US)

(21) Appl. No.: 14/215,830

(22) Filed: Mar. 17, 2014

(51) Int. Cl. G06Q 30/02

(52) U.S. Cl. CPC G06Q 30/0242

(57) ABSTRACT

Systems, methods, and computer-readable storage media that may be used to determine a cause of user abandonments in relation to a resource are provided. One method includes receiving user path data representing a plurality of user paths. The method further includes identifying a plurality of user paths ending with an abandonment event associated with a first resource. The method further includes determining a first abandonment metric indicating a first plurality of the identified user paths having a first condition of a characteristic. The method further includes determining a second abandonment metric indicating a second plurality of the identified user paths having a second condition of the characteristic. The method further includes determining whether the abandonment events associated with the first resource are at least partially related to the characteristic based on a comparison of the first abandonment metric and the second abandonment metric.

### BACKGROUND

Content providers often publish content items in networked resources through online content management systems with the goal of having an end user interact with (e.g., click through) the content items and perform a converting action, such as providing information of value to the content providers and/or purchasing a product or service offered by the content providers. A “bounce” occurs when a user visits a resource (e.g., a webpage, an application, etc.) and then leaves without engaging any further. In some implementations, a bounce rate or derivative bounce rate (e.g., bounces divided by the total number of visits) may be applied to one or more resources of a content provider and presented to the content provider as an indication of the success of the resources in engaging users. However, bounce rate is not always an accurate indicator of user intent, and can sometimes lead content providers to take undesirable actions as a result of misunderstanding the nature of some user activities.

### SUMMARY

One illustrative implementation of the disclosure relates to a method that includes receiving, at a computerized analysis system, user path data representing a plurality of user paths. Each user path includes one or more interactions of a user leading to one or more resources associated with a content provider. The method further includes identifying, by the analysis system, a plurality of user paths ending with an abandonment event associated with a first resource of the plurality of resources. Each abandonment event includes a user interaction that is not a conversion event. The method further includes determining, by the analysis system, a first abandonment metric indicating a first plurality of the identified user paths having a first condition of a characteristic. The method further includes determining, by the analysis system, a second abandonment metric indicating a second plurality of the identified user paths having a second condition of the characteristic. The method further includes determining whether the abandonment events associated with the first resource are at least partially related to the characteristic based on a comparison of the first abandonment metric and the second abandonment metric.

Another implementation relates to a system including at least one computing device operably coupled to at least one memory. The at least one computing device is configured to receive user path data representing a plurality of user paths. Each user path includes one or more interactions of a user leading to one or more resources associated with a content provider. The at least one computing device is further configured to identify a plurality of user paths ending with an abandonment event associated with a first resource of the plurality of resources. Each abandonment event includes a user interaction that is not a conversion event. The at least one computing device is further configured to determine a first abandonment metric indicating a first plurality of the identified user paths having a first condition of a characteristic and determine a second abandonment metric indicating a second plurality of the identified user paths having a second condition of the characteristic. The at least one computing device is further configured to determine whether the abandonment events associated with the first resource are at least partially related to the characteristic based on a comparison of the first abandonment metric and the second abandonment metric.

Yet another implementation relates to one or more computer-readable storage media having instructions stored thereon that, when executed by at least one processor, cause the at least one processor to perform operations. The operations include receiving user path data representing a plurality of user paths. Each user path includes one or more interactions of a user leading to one or more resources associated with a content provider. The operations further include identifying a plurality of user paths ending with an abandonment event associated with a first resource of the plurality of resources. Each abandonment event includes a user interaction that is not a conversion event. The operations further include determining a first abandonment metric indicating a first plurality of the identified user paths having a first condition of a characteristic and determining a second abandonment metric indicating a second plurality of the identified user paths having a second condition of the characteristic. The operations further include determining whether the abandonment events associated with the first resource are at least partially related to the characteristic based on a comparison of the first abandonment metric and the second abandonment metric. The operations further include providing a recommendation relating to at least one of the characteristic or the first resource based on the determination of whether the abandonment events associated with the first resource are at least partially related to the characteristic.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of an analysis system and associated environment according to an illustrative implementation.

FIG. 2 is a flow diagram of a process for determining whether abandonment events associated with a resource are at least partially related to a characteristic according to an illustrative implementation.

FIG. 3 is a flow diagram of a process for determining abandonment metrics based on a series of similar interactions according to an illustrative implementation.

FIG. 4 is a flow diagram of a process for reducing a likelihood of user abandonments according to an illustrative implementation.

FIG. 5 is a flow diagram of a process for determining and removing false positive abandonment events within the user paths according to an illustrative implementation.

FIG. 6 is a block diagram of a computing system according to an illustrative implementation.

### DETAILED DESCRIPTION

Referring generally to the Figures, various illustrative systems and methods are provided that may be used to infer reasons for user abandonments prior to conversions. Bounce rate alone can sometimes be misleading as to the intent of the consumers whose actions are used to generate the metric. For example, consider a customer who is looking to buy a product, a journey that often takes 3-4 interactions with a resource (e.g., website). As part of that journey, the customer might be looking for a product price, shipping time or phone number—all information commonly found on search landing pages (e.g., results pages presented by a search engine in response to receiving a search query from a user) without the need for additional discovery in the resource. But, as the step also reports as a bounce, content providers often misconstrue this activity as wasted interactions (e.g., clicks). As a result, the content providers may take actions, such as resource optimizations and/or changes in content auction bids, that the content providers would not necessarily take if they viewed the activities as activities potentially leading towards a conversion, rather than a bounce. This can lead to a content provider removing itself from the consideration process, simply because the customer was not ready to convert yet.

In some implementations, the systems and methods of the present disclosure may provide content providers with a more accurate idea of why customer abandonments are occurring by looking at user path data leading up to a non-converting activity, rather than considering only the last interaction. An illustrative analysis system may identify a resource associated with user abandonments. In some implementations, a user abandonment may be defined as an instance where a user interacted with the resource and did not make any further interactions, according to available interaction data. In some implementations, a user abandonment may be defined such that the last user interaction in a user path does not result in a conversion action (e.g., a purchase of a product/service). The system may retrieve user path data associated with the user abandonment events indicating one or more interaction events occurring prior to the abandonment events.

The system may analyze the user path data to infer one or more possible causes associated with the abandonment events. The system may determine abandonment rates (e.g., numbers/percentages of abandonments) associated with one or more particular characteristics, such as a source link type (e.g., paid vs. unpaid/organic keywords, search interface vs. content item displayed within a resource, such as a webpage, etc.), source campaigns, source keywords/keyword groups, etc. The system may determine abandonment rates associated with different conditions of the characteristics. If there is a substantial discrepancy in abandonment rate between conditions of the associated characteristic, the system may infer that one or more conditions of the characteristic are at least partially responsible for the abandonments. If the abandonment rate is relatively steady across conditions of the characteristic, such that the number/percentage of abandonments associated with each of the conditions is approximately the same, the system may infer that the characteristic is not responsible for the abandonments. In some such implementations, the system may infer that the resource itself may be responsible for the abandonments.

In some implementations, the analysis system may be configured to analyze multiple interactions along a plurality of non-converting user paths to determine interactions/resources that may be associated with user abandonments, but may not necessarily be the last resource with which the user interacted. For example, the system may be configured to analyze interactions in the user path data and identify trends in the earlier interactions for the non-converting paths. The system may identify a series of similar user interactions occurring in multiple non-converting user paths and determine whether the series of similar interactions are at least partially responsible for the abandonment events. In one illustrative implementation, the system may analyze user path data for interactions leading to a service cancellation page of a service provider to determine a series of interactions occurring prior to users abandoning on the cancellation page (e.g., multiple visits to technical support pages). In some implementations, the system may recommend actions to avoid future abandonments, such as intervention at some point in a series of events determined to frequently lead to abandonment (e.g., adding users to a remarking list to provide them help and/or promotional offers after detecting multiple interactions with the technical support pages).

In some implementations, the analysis system may be configured to detect false positive abandonment events and take one or more actions to prevent the false positives from impacting the analysis. For example, users may navigate to resources of a content provider on a mobile device and no longer interact with the content provider's resources on the mobile device, but may conduct further interactions with the content provider on a desktop computing device. When the user path data is associated with a device identifier, the user path data may interpret the last interaction on the mobile device as an abandonment, despite the fact that the user conducted further interactions on the mobile device. In some implementations, a joint identifier may be used to connect the mobile device path data and the desktop device path data, and determine that the last interaction on the mobile device was not an actual abandonment. In some such implementations, the analysis system may receive an identification of one or more user paths that may have been identified as non-converting paths including a user abandonment on a first device, but that are not actually non-converting paths because the interaction was continued on a second device. In some implementations, the analysis system may remove such paths from the abandonment analysis. In some implementations, the analysis system may additionally or alternatively generate a quantitative indication of how frequently one or more resources are associated with a last interaction on one device and a subsequent interaction on another device, which may indicate that the resources are driving users to the other device (e.g., the resources are not well-optimized for mobile applications).

For situations in which the systems discussed herein collect and/or utilize personal information about users, or may make use of personal information, the users may be provided with an opportunity to control whether programs or features that may collect personal information (e.g., information about a user's social network, social actions or activities, a user's preferences, a user's current location, etc.), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server. Further, the individual user information itself is not surfaced to the content provider, so the content provider cannot discern the interactions associated with particular users.

For situations in which the systems discussed herein collect and/or utilize information pertaining to one or more particular content providers, the content providers may be provided with an opportunity to choose whether to participate or not participate in the program/features collecting and/or utilizing the information. In some implementations, the information may be anonymized in one or more ways before it is utilized, such that the identity of the content provider with which it is associated cannot be discerned from the anonymized information. Additionally, data from multiple content providers may be aggregated, and data presented to a content provider may be based on the aggregated data, rather than on individualized data. In some implementations, the system may include one or more filtering conditions to ensure that the aggregated data includes enough data samples from enough content providers to prevent against any individualized content provider data being obtained from the aggregated data. The system does not present individualized data for a content provider to any other content provider.

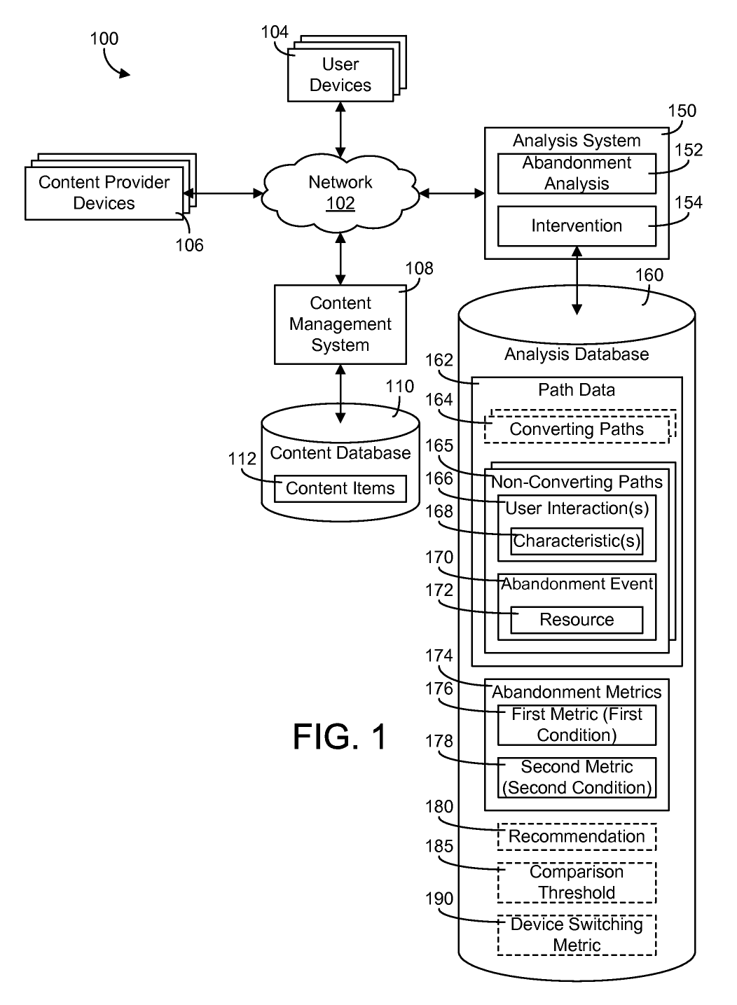

Referring now to FIG. 1, and in brief overview, a block diagram of an analysis system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access websites (e.g., using an internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content from which content management system 108 selects items may be provided by one or more content providers via network 102 using one or more content provider devices 106.

In some implementations, bids for content to be selected by content management system 108 may be provided to content management system 108 from content providers participating in an auction using devices, such as content provider devices 106, configured to communicate with content management system 108 through network 102. In such implementations, content management system 108 may determine content to be published in one or more content interfaces of resources (e.g., webpages, applications, etc.) shown on user devices 104 based at least in part on the bids.

An analysis system 150 may be configured to analyze user path data relating to interactions of one or more users of user devices 104 and infer one or more reasons why user abandonment events occur with respect to one or more resources. In some implementations, analysis system 150 may receive path data 162 that includes multiple user paths. Each user path represents one or more interactions of a user with one or more resources (e.g., webpages, applications, etc.) and/or content items (e.g., paid and/or unpaid content items displayed within a resource, such as items displayed within a search engine results interface). System 150 may identify one or more non-converting paths 165 resulting in abandonment events 170 in connection with a particular resource. System 150 may determine abandonment metrics 174 that relate to a number of non-converting paths 165 associated with different conditions of one or more characteristics. Based on abandonment metrics 174, system 150 may infer whether abandonment events 170 are at least partially related to a particular characteristic.

Referring still to FIG. 1, and in greater detail, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.).

User devices 104 and/or content provider devices 106 may be configured to receive data from various sources using a network 102. In some implementations, network 102 may comprise a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a website, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's webpage or another resource associated with the content provider. In other words, a bid amount may be a cost per click (CPC) bid amount. In another example, the bid amount may correspond to an action being performed on the third-party provider's website, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on webpages visited by the device identifier), the topic of a webpage or other first-party content with which the third-party content is to be presented, a geographic location of the client device that will be presenting the content, or a geographic location specified as part of a search query. In some cases, a selection parameter may designate a specific webpage, website, or group of websites with which the third-party content is to be presented. For example, an advertiser selling golf equipment may specify that they wish to place an advertisement on the sports page of an particular online newspaper.

Content management system 108 may also be configured to suggest a bid amount to a third-party content provider when a campaign is created or modified. In some implementations, the suggested bid amount may be based on aggregate bid amounts from the third-party content provider's peers (e.g., other third-party content providers that use the same or similar selection parameters as part of their campaigns). For example, a third-party content provider that wishes to place an advertisement on the sports page of an online newspaper may be shown an average bid amount used by other advertisers on the same page. The suggested bid amount may facilitate the creation of bid amounts across different types of client devices, in some cases. In some implementations, the suggested bid amount may be sent to a third-party content provider as a suggested bid adjustment value. Such an adjustment value may be a suggested modification to an existing bid amount for one type of device, to enter a bid amount for another type of device as part of the same campaign. For example, content management system 108 may suggest that a third-party content provider increase or decrease their bid amount for desktop devices by a certain percentage, to create a bid amount for mobile devices.

Analysis system 150 may be configured to analyze path data 162 relating to user interactions with one or more items, such as resources (e.g., webpages, applications, etc.) associated with a content provider and/or paid or unpaid content items displayed within an interface in a resource (e.g., a search engine interface), and determine a reason for one or more abandonment events reflected in path data 162. Analysis system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, analysis system 150 and content management system 108 may be implemented as separate systems or integrated within a single system (e.g., content management system 108 may be configured to incorporate some or all of the functions/capabilities of analysis system 150).

Analysis system 150 may include one or more modules (e.g., implemented as computer-readable instructions executable by a processor) configured to perform various functions of analysis system 150. Analysis system 150 may include an abandonment analysis module 152 configured to analyze path data 162 and infer whether the abandonments are related to one or more characteristics. Abandonment analysis module 152 may identify a plurality of non-converting paths 165 within path data 162. Each non-converting path 165 may include one or more user interactions 166 having associated therewith one or more characteristics 168, and may end with an abandonment event 170. Abandonment event 170 may be a user interaction with a resource 172 of the content provider, after which path data 162 does not indicate further interactions of the user with resources of the content provider (e.g., no subsequent conversion event, such as a product/service purchase).

Abandonment analysis module 152 may generate one or more abandonment metrics 174 based on non-converting paths 165. Module 152 may identify a set of non-converting paths 165 having abandonment events relating to a same resource 172 (e.g., a particular webpage, a webpage within a group of webpages under a particular domain, a particular application or group of applications, etc.). Module 152 may generate a first abandonment metric 176 indicating a first amount of the identified non-converting paths 165 exhibiting a first condition of a particular characteristic 168, and a second abandonment metric 178 indicating a second amount of the identified non-converting paths 165 exhibiting a second condition of the particular characteristic 168. Module 152 may compare first abandonment metric 176 and second abandonment metric 178 to determine whether the abandonment events associated with the particular resource 172 are at least partially related to the particular characteristic 168. In some implementations, if abandonment metrics 176 and 178 are substantially different, module 152 may infer that the abandonment events are likely related to the characteristic. In some implementations, if abandonment metrics 176 and 178 are similar, module 152 may infer that the abandonment events are unlikely related to the characteristic, and are more likely related to a different characteristic, such as the content of the resource itself

In some implementations, analysis system 150 may include an intervention module 154 configured to implement one or more actions to prevent abandonment events. In some implementations, abandonment analysis module 152 may determine that a group of abandonment events is related to a series of similar user interactions occurring prior to the abandonment events. Intervention module 154 may receive an indication that a user has completed at least one of the series of similar user interactions, and may implement actions to prevent the user from abandoning prior to a conversion, such as adding the user to a remarketing list or providing one or more options to the user to obtain assistance.

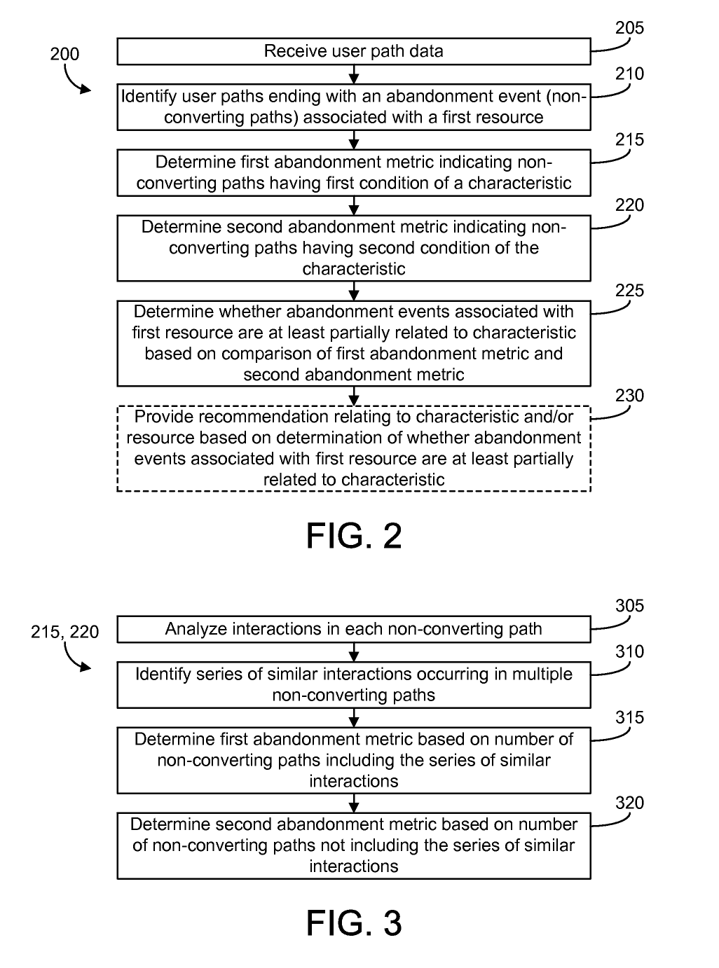

FIG. 2 illustrates a flow diagram of a process 200 for determining whether abandonment events associated with a resource are at least partially related to a characteristic according to an illustrative implementation. Referring to both FIGS. 1 and 2, analysis system 150 may be configured to receive path data 162 indicating one or more previous interactions of a user with one or more resources associated with a content provider (205). In some implementations, some of the interactions may relate to content items provided within a resource (e.g., within a content interface). The content items may include paid content items (e.g., paid items displayed within a search engine results interface and/or a different webpage, such as through the use of an auction process) and/or unpaid content items (e.g., unpaid search results displayed within a search engine results interface, unpaid links within a webpage, etc.). The content campaign may include one or more content items that the content provider wishes to have presented to user devices 104 by content management system 108. In some implementations, some of the content items may have one or more products and/or services associated with the content item. In some implementations, such content item may be designed to promote one or more particular products and/or services. In some implementations, some content items may be configured to promote the content provider, an affiliate of the content provider, a resource (e.g., website) of the content provider, etc. in general, and the products and/or services associated with the content item may be any products and/or services offered for sale through the content provider, affiliate, resource, etc.

Path data 162 may include any type of data from which information about previous interactions of a user with a content campaign can be determined. The interactions may be instances where impressions of a campaign content item have been displayed on the user device of the user, instances where the user clicked through or otherwise selected the content item, instances where the user converted (e.g., purchased a product/service as a direct or indirect result of an interaction with a campaign content item), etc.

In some implementations, path data 162 may include resource visitation data collected by analysis system 150 describing some or all activities leading to a website or other resource of the content provider. Analysis system 150 may collect information relating to a portion of the resource visited/accessed, an identifier associated with the user device that accessed the resource, information relating to an origin or previous location that the user/device last visited before accessing the resource, information relating to a trigger that caused the user device (e.g., device browser application) to navigate to the resource (e.g., the user manually accessing the resource, such as by typing a URL in an address bar, a link associated with a content item selected on the user device causing the user device to navigate to the resource, etc.), and/or other information relating to the user interaction with the resource. In some implementations, path data 162 may include one or more keywords associated with content items through which the resource was accessed.

In some implementations, path data 162 may include result data associated with a resource visit or other user interaction with one or more content items of the content campaign. The result data may indicate whether the visit resulted in the purchase of one or more products or services, an identity of any products/services purchased, a value of any purchased products/services, etc. In some implementations, path data 162 may be configured to follow a path from a first user visit to the resource and/or interaction with a content item of the content campaign to one or more conversions resulting from visits/interactions. The full path from a first user interaction to a converting action, such as a purchase or provision of information requested by a content provider, may be referred to as a converting path. In some implementations, path data 162 may include data relating to multiple conversion paths 164.

In various implementations, path data 162 may reflect one or more of a variety of different types of user interactions. In some illustrative implementations, the interactions may include viewing a content item impression, clicking on or otherwise selecting a content item impression, viewing a video, listening to an audio sample, viewing a webpage or other resource, and/or any other type of engagement with a resource and/or content item displayed thereon. In some implementations, the interactions may include any sort of user interaction with content without regard to whether the interaction results in a visit to a resource, such as a webpage. In one illustrative implementation, a user A may click on N events followed by a paid search click where user A effectively abandons consideration of the content provider. The content provider may still have added user A to a list to continue to send user A content items. The user path for such an illustrative implementation may be represented as follows: N events>Paid Search>Display Impression>Display Impression. In some implementations, analysis system 150 may extract information relating to the paid search interaction, as it results in a click and site visit with potential for optimization, as opposed to the display impressions of the subsequent content items, which were effectively directed to a disinterested user.

In various implementations, an identifier may be a browser cookie, a unique device identifier (e.g., a serial number), a device fingerprint (e.g., collection of non-private characteristics of the user device), or another type of identifier. The identifier may not include personally identifiable data from which an actual identity of the user can be discerned. Analysis system 150 may be configured to require consent from the user to tie an identifier to path data 162. In some implementations, path data from multiple sources may be utilized even if the path data sets reference different types of identifiers. For example, user paths may be joined by matching one identifier (e.g., browser cookie) with another identifier (e.g., a device identifier) to associate both path data sets as corresponding to a single user.

Analysis system 150 may be configured to identify a plurality of non-converting paths 165 within path data 162 associated with a particular resource (210). Non-converting paths 165 may be paths that end with an abandonment event 170, such that path data 162 indicates that the user interacted with a resource 172 and had no further interaction with resources of the content provider, and did not perform a conversion action (e.g., a purchase of a product/service of the content provider). Each non-converting path 165 may include one or more user interactions 166 leading to an abandonment event 170 associated with a resource 172. In some instances, interactions 166 may include, for example, one or more resources visited before resource 172 associated with abandonment event 170, one or more content items with which the user interacted before visiting resource 172 (e.g., content items impressions presented to the user, content items clicked by the user, etc.). Analysis system 150 may identify a set of non-converting paths 165 associated with a particular resource 172, such as a particular webpage, one of a group of webpages (e.g., webpages published within a particular domain), a particular content item or group of content items, etc.

In some implementations, one or more of user interactions 166 of non-converting paths 165 may have one or more associated characteristics 168. Characteristics 168 may relate to a variety of aspects of interactions 166. In various implementations, characteristics 168 may include a channel type (e.g., paid/unpaid search content item, paid/unpaid display content item, affiliate network content item, email item, etc.), a content item creative identity or type (e.g., image, video, text, etc.), a content campaign identity, a remarketing list associated with the interaction (e.g., if the user was presented with a content item as a result of being placed on a remarketing list), one or more keywords associated with the interaction (e.g., keywords associated with a bid for a paid content item displayed to the user), characteristics associated with a user and/or user device (e.g., geographic location, device identity/type, etc.), and/or other types of characteristics. In some implementations, one or more customized characteristics may be defined by the content provider and determined based on characteristics 168 associated with interactions 166, such as a customer lifetime value determined for the user, whether the user is part of a catalog distribution list, etc. In such implementations, analysis system 150 may receive input from the content provider and determine the customized characteristics without surfacing any individualized data about particular users to the content provider.

Analysis system 150 may determine a first abandonment metric 176 indicating a first amount of the identified non-converting paths 165 relating to the particular resource that have a first condition of a particular characteristic 168 (215). Analysis system 150 may also determine a second abandonment metric 178 indicating a second amount of the identified non-converting paths relating to the particular resource that have a second condition of the characteristic 168 (220). In some implementations, metrics 176 and/or 178 may include one or both of a number of non-converting user paths 165 or a percentage of non-converting user paths 165. In some implementations, the content provider may be provided with an interface allowing the content provider to specify the characteristic upon which metrics 176 and 178 are based.

The characteristic and conditions thereof used to determine metrics 176 and 178 may vary according to different illustrative implementations. In some implementations, the first and second conditions of a characteristic may be a presence and absence of the condition, respectively. In one such illustrative implementation, first abandonment metric 176 may indicate a number of the identified non-converting paths 165 where the user had visited a particular website prior to the abandonment event, and second abandonment metric 178 may indicate a number of the identified non-converting paths 165 where the user had not visited the particular website. In some implementations, the first and second conditions of the characteristic may be different values or types of the characteristic. In one such illustrative implementation, the characteristic may be a channel type, and first abandonment metric 176 may indicate a number of the identified non-converting paths 165 where the user had linked to the abandoning resource through a first channel (e.g., a content item displayed in a search engine interface), and second abandonment metric 178 may indicate a number of the identified non-converting paths 165 where the user had linked to the abandoning resource through a second channel (e.g., email). In some implementations, more than two abandonment metrics may be determined and used to compare abandonment numbers/rates across several different conditions of a characteristic.

In some implementations, the characteristic to which metrics 176 and 178 are directed may be characteristics of a second-to-last interaction of the user immediately preceding the abandonment events in the identified non-converting paths 165. In one illustrative implementation, first abandonment metric 176 may indicate a number of the identified non-converting paths 165 where the user linked to the abandoning resource from a first paid search content item displayed to the user based on a first keyword, and second abandonment metric 178 may indicate a number of the identified non-converting paths 165 where the user linked to the abandoning resource from a second paid search content item displayed to the user based on a second keyword. In other illustrative implementations, metrics 176 and/or 178 may be based on characteristics such as a content item, content item group, and/or content campaign associated with the second-to-last interactions, keywords associated with the second-to-last interactions, resources (e.g., webpages, websites, domains, applications, etc.) associated with the second-to-last interactions, whether a link leading to the abandoning resource and associated with the second-to-last interactions was presented to the user as a result of a paid bid or as an unpaid item, etc.

Analysis system 150 may determine whether the abandonment events associated with the particular resource are at least partially related to the characteristic based on comparison of first abandonment metric 176 and second abandonment metric 178 (225). In some implementations, if there is a significant difference in first abandonment metric 176 and second abandonment metric 178 (e.g., indicating that the number/percentage of instances of abandonment differs significantly based on the condition of the characteristic), system 150 may infer that the abandonment events are at least partially related to the characteristic. In some implementations, if metrics 176 and 178 are similar (e.g., indicating that the number/percentage of abandonments does not vary substantially based on the condition of the characteristic), system 150 may infer that the abandonment events are likely largely unrelated to the characteristic. In some implementations, system 150 may determine whether the abandonment events are related to the characteristic based on a comparison threshold 185. In some such implementations, if the difference (e.g., absolute or percentage difference) between metrics 176 and 178 is less than threshold 185, system 150 may determine that the abandonment events are unrelated to the characteristic, and if the difference between metrics 176 and 178 is greater than threshold 185, system 150 may determine that the abandonment events are at least partially related to the characteristic. In some implementations, system 150 may infer that the content of the abandoning resource itself is likely related to the abandonment events (e.g., when the instances of abandonment do not vary significantly across multiple conditions of multiple characteristics).

In one illustrative implementation, ten customers may abandon upon reaching a particular resource, such as a webpage. Nine of the customers may have linked to the webpage through a content item displayed based on a paid search keyword X, and one may have linked through a content item displayed based on a paid search keyword Y. Assuming relatively equal traffic, the analysis system may infer that the abandonments were at least partially the result of a keyword abandonment issue (e.g., customers who linked based on keyword X did not find the webpage relevant). If a comparable number of abandoning customers linked through items associated with keyword X as with items associated with keyword Y, the system may infer that there is a different issue leading to abandonment, such as a different characteristic or the content of the webpage itself.

In some implementations, analysis system 150 may provide one or more recommendations 180 relating to the characteristic and/or abandoning resource based on the determination of whether the abandonment events associated with the abandoning resource are at least partially related to the characteristic (230). In one illustrative implementation, if system 150 determines that one or more particular paid search keywords associated with content items linking to the abandoning resource are related to high abandonment rates, system 150 may provide a recommendation that the content provider consider modifying the set of keywords used to link to the resource (e.g., to remove the keywords associated with the high abandonment rate). In another illustrative implementation, if system 150 determines that abandonment rates were lower when the resource was linked off of paid content items displayed from a first webpage display network as compared to paid content items displayed from a second search engine network, system 150 may provide a recommendation that the content provider consider emphasizing (e.g., increasing a budget) content items in the first webpage display network. In yet another illustrative implementation, if system 150 determines that abandonment rates are relatively steady across multiple characteristics, system 150 may infer that the issue leading to abandonments is in the content of the resource itself, and system 150 may provide a recommendation that the content provider consider modifying the content of the resource.

In some implementations, system 150 may be configured to determine whether a series of similar user interactions within non-converting paths 165 is related to the abandonment events. FIG. 3 illustrates a flow diagram of a process for determining abandonment metrics based on a series of similar interactions according to an illustrative implementation. In some implementations, the process shown in FIG. 3 may be used to determine metrics 176 and 178 (see operations 215, 220 of process 200) in the context of analyzing one or more series of interactions.

System 150 may analyze user interactions 166 in each non-converting path 165 relating to a particular resource (305) and identify a series of similar interactions occurring in multiple non-converting paths 165 (310). In some implementations, system 150 may be configured to identify patterns of similar interactions with non-converting paths 165 using a machine-learning process. System 150 may be configured to identify any combinations of characteristics and/or conditions thereof present in multiple non-converting paths 165. In one illustrative implementation, system 150 may determine that several non-converting paths 165 are associated with a chain of interactions in which the user first visits a search engine and clicks on an organic search item within a results interface, then later visits the search engine and clicks on a paid search item resulting from a first keyword, then visits the search engine again and clicks on a paid search item resulting from a second keyword, which directs the user to the abandoning resource. In another illustrative implementation, system 150 may determine that non-converting paths 165 with abandonment events associated with a cancellation page of a media service provider frequently include user interactions with at least four technical support webpages of the service provider prior to abandonment on the cancellation page. This may indicate that it is user dissatisfaction with the technical support pages, rather than the cancellation page, contributing to the abandonment events. In some such implementations, system 150 may provide a recommendation that the content provider consider revising the technical support section of its website.

System 150 may determine first abandonment metric 176 based on a number of non-converting paths 165 including the series of similar interactions (315), and may determine second abandonment metric 178 based on a number of non-converting paths 165 not including the series of similar interactions (320). Based on metrics 176 and 178, system 150 may infer whether the abandonment events are at least partially related to the series of similar interactions.

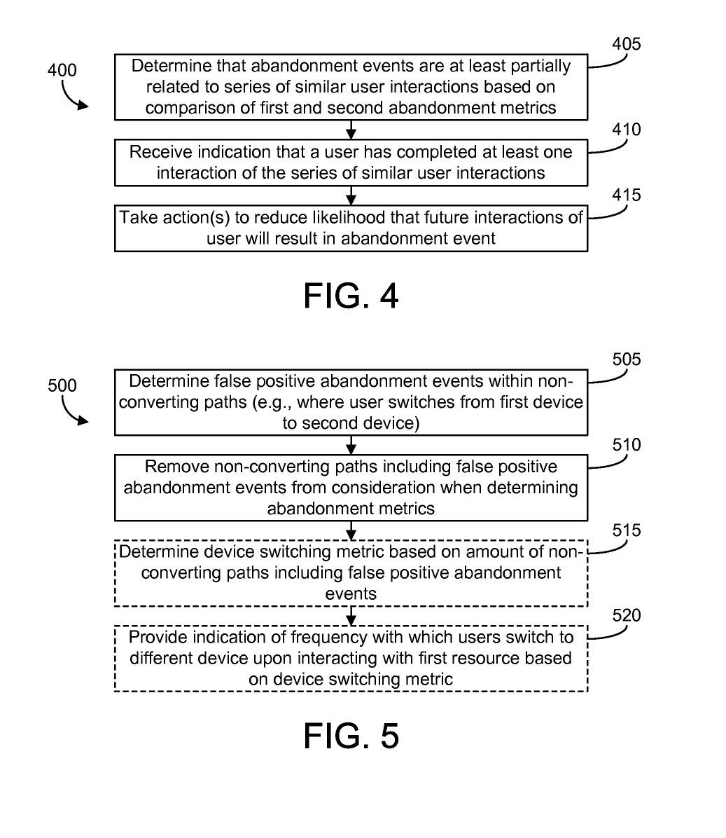

In some implementations, system 150 may be configured to take one or more actions to reduce a likelihood of future abandonments (e.g., when system 150 determines that a series of similar interactions is likely at least partially responsible for abandonments). FIG. 4 illustrates a process 400 for reducing a likelihood of user abandonments according to an illustrative implementation. Abandonment analysis module 152 of system 150 may determine that the abandonment events are at least partially related to the series of similar user interactions based on a comparison of first abandonment metric 176 and second abandonment metric 178 (405).

Subsequently, intervention module 154 may be configured to receive an indication that a user has completed at least one interaction of the series of similar user interactions (410). Intervention module 154 may be configured to receive indications of one or more user interactions prior to completion of a full converting or non-converting path. Intervention module 154 may be configured to receive the user interaction data and take one or more actions based on predetermined settings, without surfacing any information about the user interactions to the content provider.

Intervention module 154 may take one or more actions to reduce a likelihood that future interactions of the user will result in an abandonment event (415). In some implementations, intervention module 154 may add the user to a remarking list upon completion of one or more of the series of interactions determined to be related to abandonments. In one such implementation, intervention module 154 may add the user to a remarketing list when the user has reached a technical support page, or has navigated to more than two technical support pages, before the user reaches a cancellation page. In such an implementation, the remarketing list may be used to send technical support information or an offer of assistance to the user, or to increase a bid multiplier for content items in auctions for items to be presented to a device of the user. In other implementations, the user may be provided with a promotional offer or one or more messages (e.g., emails).

In some instances, some user paths may be incorrectly interpreted as non-converting paths ending in abandonment events. In some implementations, a user may complete one or more interactions on a first device, such as a mobile device, then move to a second device (e.g., a desktop or laptop computer) to complete additional interactions, the last of which may be a conversion action (e.g., a product purchase). In such implementations, path data 162 may not connect the interactions on the first device with those on the second device, and system 150 may improperly interpret the last interaction on the first device as an abandonment.

FIG. 5 is a flow diagram of a process 500 for determining and removing false positive abandonment events within the user paths according to an illustrative implementation. System 150 may determine one or more false positive abandonment events within non-converting paths 165 (505). In some implementations, system 150 may utilize an identifier or other signal associated with a path indicating that the user interactions associated with the path are continued on another path associated with another device. Based on the data, system 150 may determine whether a non-converting path 165 includes a false positive abandonment event, such that the user interactions were continued as reflected in another path associated with another device. System 150 may remove any non-converting paths 165 including the false positive abandonment events from consideration when determining abandonment metrics 174 (510).

In some implementations, system 150 may determine whether a particular resource tends to drive users to switch from a first device to a second device, perhaps indicating that the resource is not optimized for interaction via the first device (e.g., not well optimized for mobile devices). System 150 may determine a device switching metric 190 based on an amount (e.g., number/percentage) of non-converting paths 165 associated with a particular resource that include the false positive abandonment events (515). Based on device switching metric 190, system 150 may provide an indication of a frequency (e.g., relative frequency, such as high, medium, or low frequency) with which users switched to a different device upon interacting with the resource (520). This may help the content provider decide whether the resource should be modified for better interaction with the first device. In some implementations, the indication may be provided only if the amount of underlying user paths upon which the indication is based exceeds a threshold level to ensure that the recommendation is not based on a small sample of data.

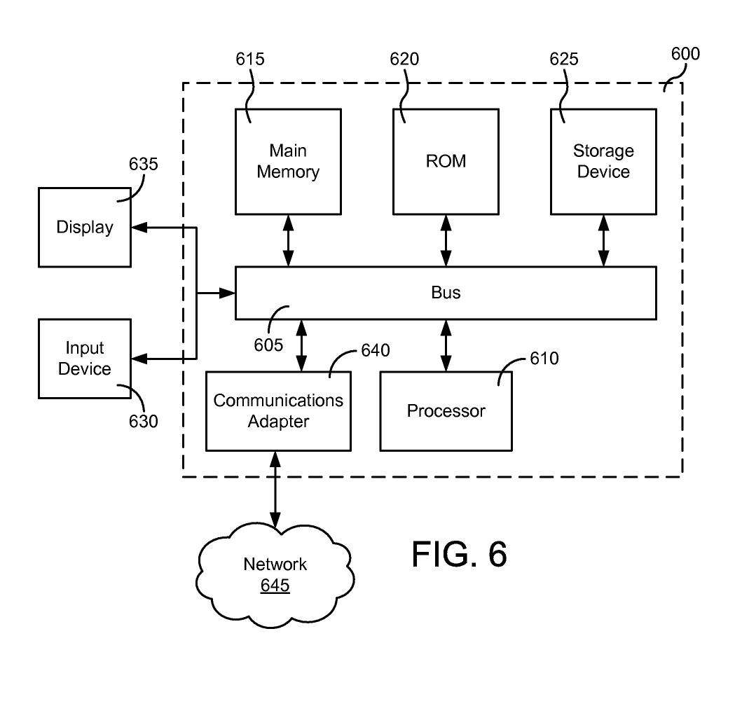

FIG. 6 illustrates a depiction of a computer system 600 that can be used, for example, to implement an illustrative user device 104, an illustrative content management system 108, an illustrative content provider device 106, an illustrative analysis system 150, and/or various other illustrative systems described in the present disclosure. The computing system 600 includes a bus 605 or other communication component for communicating information and a processor 610 coupled to the bus 605 for processing information. The computing system 600 also includes main memory 615, such as a random access memory (RAM) or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a read only memory (ROM) 610 or other static storage device coupled to the bus 605 for storing static information and instructions for the processor 610. A storage device 625, such as a solid state device, magnetic disk or optical disk, is coupled to the bus 605 for persistently storing information and instructions.

The computing system 600 may be coupled via the bus 605 to a display 635, such as a liquid crystal display, or active matrix display, for displaying information to a user. An input device 630, such as a keyboard including alphanumeric and other keys, may be coupled to the bus 605 for communicating information, and command selections to the processor 610. In another implementation, the input device 630 has a touch screen display 635. The input device 630 can include a cursor control, such as a mouse, a trackball, or cursor direction keys, for communicating direction information and command selections to the processor 610 and for controlling cursor movement on the display 635.

In some implementations, the computing system 600 may include a communications adapter 640, such as a networking adapter. Communications adapter 640 may be coupled to bus 605 and may be configured to enable communications with a computing or communications network 645 and/or other computing systems. In various illustrative implementations, any type of networking configuration may be achieved using communications adapter 640, such as wired (e.g., via Ethernet), wireless (e.g., via WiFi, Bluetooth, etc.), pre-configured, ad-hoc, LAN, WAN, etc.

According to various implementations, the processes that effectuate illustrative implementations that are described herein can be achieved by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes described herein. One or more processors in a multi-processing arrangement may also be employed to execute the instructions contained in main memory 615. In alternative implementations, hard-wired circuitry may be used in place of or in combination with software instructions to implement illustrative implementations. Thus, implementations are not limited to any specific combination of hardware circuitry and software.

Although an example processing system has been described in FIG. 6, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The term “data processing apparatus” or “computing device” encompasses all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services (e.g., Netflix, Vudu, Hulu, etc.), a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, at a computerized analysis system, user path data representing a plurality of user paths, each user path comprising one or more interactions of a user leading to one or more resources associated with a content provider;
identifying, by the analysis system, a plurality of user paths ending with an abandonment event associated with a first resource of the plurality of resources, each abandonment event comprising a user interaction that is not a conversion event;
determining, by the analysis system, a first abandonment metric indicating a first plurality of the identified user paths having a first condition of a characteristic;
determining, by the analysis system, a second abandonment metric indicating a second plurality of the identified user paths having a second condition of the characteristic; and
determining whether the abandonment events associated with the first resource are at least partially related to the characteristic based on a comparison of the first abandonment metric and the second abandonment metric.

2. The method of claim 1, wherein the characteristic to which the first abandonment metric and the second abandonment metric are directed is a characteristic of second-to-last interactions of the user immediately preceding the abandonment events in the identified user paths.

3. The method of claim 2, wherein the characteristic comprises at least one of a content item associated with the second-to-last interactions, a content campaign associated with the second-to-last interactions, one or more paid keywords based upon which the content item associated with the second-to-last interactions was selected to be presented to the user, or whether a link leading to the first resource and associated with the second-to-last interactions was provided as a result of a paid bid.

4. The method of claim 1, further comprising providing a recommendation relating to at least one of the characteristic or the first resource based on the determination of whether the abandonment events associated with the first resource are at least partially related to the characteristic.

5. The method of claim 1, wherein the characteristic to which the first abandonment metric and the second abandonment metric are directed is selected by the content provider.

6. The method of claim 1, wherein determining the first abandonment metric and the second abandonment metric comprises:
analyzing a plurality of interactions in each identified user path preceding the abandonment event;
identifying a series of similar user interactions occurring in multiple of the identified user paths;
determining the first abandonment metric based on a number of the identified user paths including the series of similar user interactions; and
determining the second abandonment metric based on a number of the identified user paths not including the series of similar user interactions.

7. The method of claim 6, further comprising:
determining that the abandonment events are at least partially related to the series of similar user interactions based on the comparison of the first abandonment metric and the second abandonment metric;
receiving an indication that a first user has completed at least one user interaction of the series of similar user interactions; and
taking one or more actions to reduce a likelihood that future interactions of the first user will result in an abandonment event.

8. The method of claim 1, further comprising:
determining one or more false positive abandonment events within the plurality of identified user paths, wherein each of the one or more false positive abandonment events comprises the last user interaction after which the user does not interact with the one or more resources on a first device, but after which the user interacts with the one or more resources on a second device; and
removing the identified user paths including the false positive abandonment events from consideration when determining the first abandonment metric and the second abandonment metric.

9. The method of claim 8, further comprising:
determining a device switching metric based on an amount of the identified user paths including the false positive abandonment events; and
providing an indication of a frequency with which users switch to a different device upon interacting with the first resource based on the device switching metric.

10. The method of claim 1, wherein the first abandonment metric and the second abandonment metric comprise at least one of a number of identified user paths or a percentage of identified user paths.

11. A system comprising:
at least one computing device operably coupled to at least one memory and configured to:
receive user path data representing a plurality of user paths, each user path comprising one or more interactions of a user leading to one or more resources associated with a content provider;
identify a plurality of user paths ending with an abandonment event associated with a first resource of the plurality of resources, each abandonment event comprising a user interaction that is not a conversion event;
determine a first abandonment metric indicating a first plurality of the identified user paths having a first condition of a characteristic;
determine a second abandonment metric indicating a second plurality of the identified user paths having a second condition of the characteristic; and
determine whether the abandonment events associated with the first resource are at least partially related to the characteristic based on a comparison of the first abandonment metric and the second abandonment metric.

12. The system of claim 11, wherein the characteristic to which the first abandonment metric and the second abandonment metric are directed is a characteristic of second-to-last interactions of the user immediately preceding the abandonment events in the identified user paths, and wherein the characteristic comprises at least one of a content item associated with the second-to-last interactions, a content campaign associated with the second-to-last interactions, one or more paid keywords based upon which the content item associated with the second-to-last interactions was selected to be presented to the user, or whether a link leading to the first resource and associated with the second-to-last interactions was provided as a result of a paid bid.

13. The system of claim 11, further comprising providing a recommendation relating to at least one of the characteristic or the first resource based on the determination of whether the abandonment events associated with the first resource are at least partially related to the characteristic.

14. The system of claim 11, wherein the characteristic to which the first abandonment metric and the second abandonment metric are directed is selected by the content provider.

15. The system of claim 11, wherein determining the first abandonment metric and the second abandonment metric comprises:
analyzing a plurality of interactions in each identified user path preceding the abandonment event;
identifying a series of similar user interactions occurring in multiple of the identified user paths;
determining the first abandonment metric based on a number of the identified user paths including the series of similar user interactions; and
determining the second abandonment metric based on a number of the identified user paths not including the series of similar user interactions.

16. The system of claim 15, further comprising:
determining that the abandonment events are at least partially related to the series of similar user interactions based on the comparison of the first abandonment metric and the second abandonment metric;
receiving an indication that a first user has completed at least one user interaction of the series of similar user interactions; and
taking one or more actions to reduce a likelihood that future interactions of the first user will result in an abandonment event.

17. The system of claim 11, further comprising:
determining one or more false positive abandonment events within the plurality of identified user paths, wherein each of the one or more false positive abandonment events comprises the last user interaction after which the user does not interact with the one or more resources on a first device, but after which the user interacts with the one or more resources on a second device; and
removing the identified user paths including the false positive abandonment events from consideration when determining the first abandonment metric and the second abandonment metric.

18. One or more computer-readable storage media having instructions stored thereon that, when executed by at least one processor, cause the at least one processor to perform operations comprising:
receiving user path data representing a plurality of user paths, each user path comprising one or more interactions of a user leading to one or more resources associated with a content provider;
identifying a plurality of user paths ending with an abandonment event associated with a first resource of the plurality of resources, each abandonment event comprising a user interaction that is not a conversion event;
determining a first abandonment metric indicating a first plurality of the identified user paths having a first condition of a characteristic;
determining a second abandonment metric indicating a second plurality of the identified user paths having a second condition of the characteristic;
determining whether the abandonment events associated with the first resource are at least partially related to the characteristic based on a comparison of the first abandonment metric and the second abandonment metric; and
providing a recommendation relating to at least one of the characteristic or the first resource based on the determination of whether the abandonment events associated with the first resource are at least partially related to the characteristic.

19. The one or more computer-readable storage media of claim 18, wherein determining the first abandonment metric and the second abandonment metric comprises:
analyzing a plurality of interactions in each identified user path preceding the abandonment event;
identifying a series of similar user interactions occurring in multiple of the identified user paths;
determining the first abandonment metric based on a number of the identified user paths including the series of similar user interactions; and
determining the second abandonment metric based on a number of the identified user paths not including the series of similar user interactions.

20. The one or more computer-readable storage media of claim 19, the operations further comprising:
determining that the abandonment events are at least partially related to the series of similar user interactions based on the comparison of the first abandonment metric and the second abandonment metric;
receiving an indication that a first user has completed at least one user interaction of the series of similar user interactions; and
taking one or more actions to reduce a likelihood that future interactions of the first user will result in an abandonment event.
